(19) United States
(12) Patent Application Publication
(10) Pub. No.: US 2025/0100173 A1
(43) Pub. Date: Mar. 27, 2025

(54) A BATTERY POWERED CHAINSAW COMPRISING AT LEAST ONE HANDLE HEATING ELEMENT

(71) Applicant: HUSQVARNA AB, Huskvarna (SE)

(72) Inventors: Joakim SAMEFORS, Huskvarna (SE); Jacob KRANTZ, Huskvarna (SE); Fredrik MOLL, Huskvarna (SE); Mattias CONNYSSON, Huskvarna (SE); Rebecca JONASSON, Huskvarna (SE)

(21) Appl. No.: 18/729,653

(22) PCT Filed: Dec. 21, 2022
(86) PCT No.: PCT/SE2022/051213

§ 371 Date: Jul. 17, 2024

(30) Foreign Application Priority Data
Jan. 21, 2022 (SE) 2250056-5

(51) Int. Cl. B27B 17/00; B27B 17/02

(52) U.S. Cl. CPC B27B 17/0008; B27B 17/02

(57) ABSTRACT

The present disclosure relates to a battery-powered chainsaw (1) comprising a cutting tool in the form of a saw chain (4) running on a guide bar, a front handle (7) at least partially extending transverse to the elongation of the guide bar and a rear handle (5) extending, at least partially, approximately in the elongated direction of the guide bar. A battery-operated heating unit comprising a first heating element (15) in the rear handle, a second heating element (13) in the front handle, and a temperature sensor (17) located in either of the rear or front handle. The heating unit (19) is configured to provide power to the first and second heating element based on a reading from the temperature sensor (17). Upon activation, a temporary power boost is provided to the first and second heating elements and subsequently a steady state power, lower than the power of the power boost.

### Technical field

The present disclosure relates to a battery-powered chainsaw comprising a cutting tool in the form of a saw chain running on a guide bar, a front handle at least partially extending transverse to the elongation of the guide bar and a rear handle extending, at least partially, approximately in the elongated direction of the guide bar.

### BACKGROUND

Such battery-powered chainsaws have become increasingly more popular with improved battery technologies and in many cases replace chainsaws powered by internal combustion engines, especially in cases where saws are used only sporadically, such as for hobby use, or when light weight is especially important, such as for climbing arborists.

It has been desired to include handle heating also in battery powered chainsaws to achieve more comfortable use of the chainsaw. However, this can be difficult in view of the power restrictions resulting from use of batteries.

### SUMMARY

One object of the present disclosure is therefore to provide a battery powered chainsaw with handle heating capability in an efficient manner.

This object is achieved by a battery powered chainsaw as defined in claim 1. More specifically, in a battery powered chainsaw of the initially mentioned kind, a battery-powered heating unit is provided comprising at least one heating element in one of the rear handle and the front handle, and a temperature sensor. The heating unit is configured to provide power to the handle/handles based on a reading from the temperature sensor. The heating unit is also configured to provide, upon activation, a temporary power boost. Subsequently, the heating unit provides a steady state power, lower than the power of the power boost. This allows the chainsaw to obtain a reasonably heated handle relatively quickly without depleting the battery too quickly during prolonged use.

The battery-operated heating unit may comprise a first heating element in the rear handle and a second heating element in the front handle. The temperature sensor may be located in the rear handle, for instance.

If two heating elements, the first and second, are provided, they may be series connected.

The duration and level of the power boost may be determined based on a temperature reading acquired at start or activation of the chainsaw. Alternatively, the power boost may be continuously controlled based on a PI-controller, for instance.

The chainsaw may comprise a compartment for a battery, and optionally a short-range communications interface.

### BRIEF DESCRIPTION OF THE DRAWINGS

FIG. 1 shows the body of a battery-operated chainsaw.

FIG. 2 illustrates the chainsaw of FIG. 1 with heated areas highlighted.

FIG. 3 illustrates the wiring of the handle heating.

FIG. 4 shows the heating of the rear handle.

FIG. 5 is a flow chart illustrating the provision of power to the handles.

### DETAILED DESCRIPTION

Chainsaws with handle heating are appreciated, especially by professional forestry workers in cold climates. A chainsaw should be maneuvered with firm grips on the chainsaw handles and this conveys heat very efficiently from the user's hands, even if wearing gloves, resulting in uncomfortably cold hands unless the chainsaw handles are heated.

Early on, chainsaws were provided with handles where some exhaust from the chainsaws internal combustion engine was led through a handle which was heated thereby. In more recent developments, a small generator has been connected to the internal combustion engine, and the electrical energy produced thereby has been used to heat chainsaw handles. In a battery-powered chainsaw however, the available energy is scarcer. Despite the significant improvement in battery technology in recent decades, the energy density is quite low compared to gasoline, and a battery of course needs access to an electric grid or the like to be recharged. Using a large proportion of the available energy for handle heating is not a viable option. Therefore, a more careful approach is needed to achieve handle heating in a battery-powered chainsaw as will be described in the following.

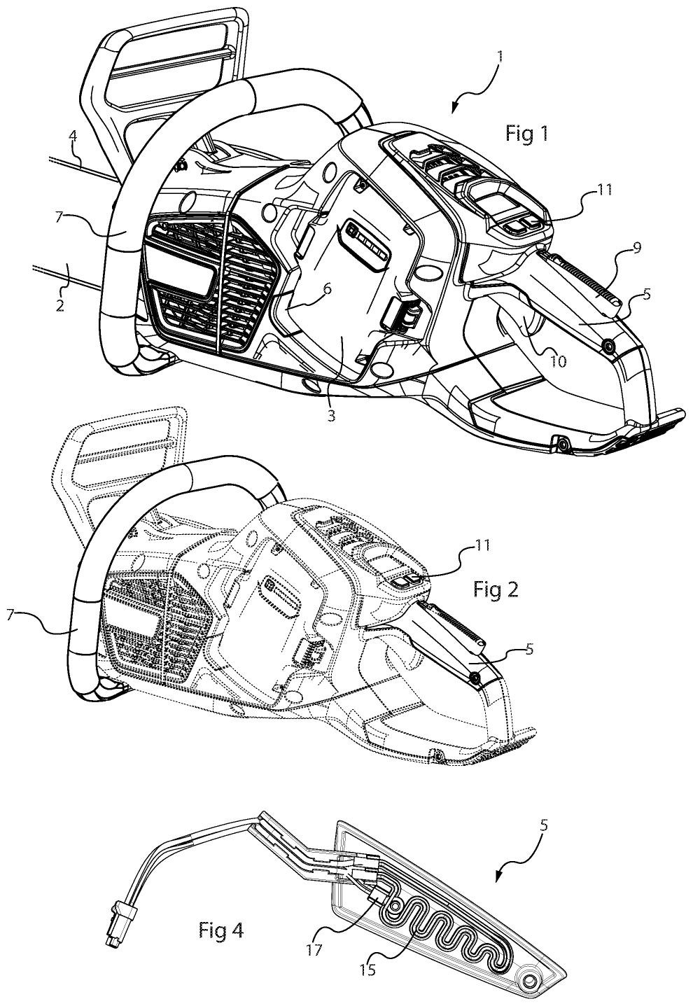

FIG. 1 illustrates a chainsaw 1 powered by a battery 3, which is replaceably fitted in a battery compartment 6. The chainsaw 1 has a similar general constitution as a legacy chainsaw, powered by an internal combustion engine, and has a guide bar 2 on which a saw chain 4 runs, powered by an electric motor. It thus comprises a rear handle 5 and a front handle 7. The rear handle 5 is intended to be held by the user's right hand and comprises a lock button 9 that must be pressed down to allow activation of a throttle button 10, the latter being operated by the user's index- and middle fingers or by the user's thumb depending on the orientation of the chainsaw 1. The front handle 7 is intended for the left hand which may be placed at various locations along the front handle 7 depending on which operation is carried out.

The handle heating may be controlled by a user interface including buttons 11, for instance. FIG. 2 highlights areas of the rear 5 and front 7 handles that can be heated as a result. If a lower power consumption is desired, it is however possible to heat a smaller portion of the front handle 7. Alternatively, it is also possible to heat only one handle, such as the rear handle 5.

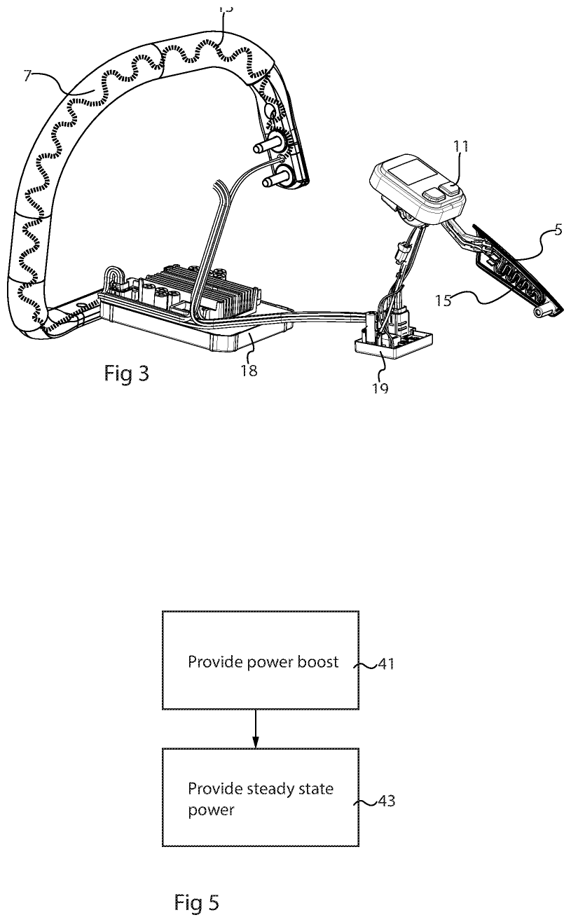

Instead of setting the heating with the illustrated user interface 11, or in combination therewith, it would be possible to provide the chainsaw 1 with a short-range communications interface such as BLUETOOTH and control the heating by means of a nearby smartphone, for instance. It is also possible to store user-specific settings that are activated based on identifying the current user and base the set desired temperature thereon. As yet another option, it is possible to identify the present use situation, e.g. tree felling or firewood cutting, and to base the set temperature depending on use. FIG. 3 illustrates the wiring of the handle heating unit 19 which connects to the normal electric system 18 of the chainsaw, used to control the chainsaw motor, which therefore also can be considered to comprise the heating unit 19. There is thus provided resistive heating elements 13, 15 to the front and rear handles 7, 5, respectively. Those resistive heating elements are dimensioned keeping the specific heat of the respective handles in mind as well as the expected radiation from the handles 5, 7. Therefore a resistive heating wire 13 of the front handle 7 is devised to generate more heat for a given setting as the front handle is bigger and made in metal which radiates heat to the surroundings to a greater extent. It is however possible to drive a single current through both heating wires 13, 15 in a series connection.

Heating may be provided with a resistive heating wire, or by a resistive conductor on a printed circuit board. Typically, in the rear handle a copper conductor of about 1.2 m may be provided, printed meandering on a circuit board.

FIG. 4 shows the heating of the rear handle 5 in greater detail where the heating conductor 15 runs therethrough. A temperature sensor 17 is located in the rear handle to provide a reading of the instantaneous temperature. It would be possible to place the sensor 17 in the front handle 7 as an alternative or to place a temperature sensor in each handle.

The sensor may typically be a an NTC-resistor, although other components such as PTC-or RTD-resistors are conceivable as well. In principle, it would also be possible to measure the voltage drop over one of the heating elements to provide a temperature reading.

However, locating the temperature sensor 17 in the rear handle is more suitable for production as this handle is usually made in plastic and can be provided with a removable shell part to facilitate mounting in the handle 5, which part is removed in FIG. 4. The front handle 7 in contrast is usually made by from a bent metal tube. Also, using one and only one temperature sensor for both handles as shown still provides the possibility of carrying out the control scheme to be discussed, while of course providing reduced costs as compared to using two or more sensors. It should be noted that in some versions of the control scheme to be discussed it is as useful to place the sensor at another location than in the handles.

Very generally thus, the present disclosure with reference to FIG. 1 provides a battery-powered chainsaw 1 comprising a cutting tool, typically in the form of a saw chain 4 running on a guide bar 2. A front handle 7 extends at least partially transverse to the elongation of the guide bar 2 and a rear handle 5 extends, at least partially, approximately in the elongated direction of the guide bar 2. With reference to FIG. 3, a battery-operated heating unit includes a first heating element 15 in the rear handle 5, a second heating element 13 in the front handle 7, and a temperature sensor 17.

The following control mechanism is devised to provide comfortable handle heating without excessively wasting battery power. When the user first begins to operate the chainsaw, the handles are likely close to the same temperature as the ambient air, which may be several degrees Celsius below zero in winter conditions. This may be very uncomfortable, especially if the user wears thin gloves or even no gloves at all. There is therefore a desire to raise the temperature in the handles 5, 7 quickly by providing a high energy flow thereto.

However, as the handles come closer to a comfortable temperature, it should instead be preferred to conserve battery power. Also, after working physically for a while, the user may find somewhat cooler handles more comfortable.

Therefore, in the present disclosure, the heating unit 19 is configured to provide power to the first 15 and second 13 heating element based on a reading from the temperature sensor 17. More specifically, the heating unit 19 provides, upon activation, a temporary power boost to the first and second heating elements 15, 13.

Subsequently, a steady state power may be provided to the first 15 and second 13 heating elements, lower than the power of the power boost. This can be visualized in a very basic manner by the flow chart of FIG. 5 illustrating the steps of providing 41 a power boost and subsequently providing 43 a steady state power.

There are different, more specific ways of accomplishing this. To start with, in a first example, it is possible to measure the temperature by means of the sensor 17 at the start or activation of the chainsaw 1 and to determine a duration and/or level of a power boost, for instance providing about 60 W for a few minutes, and then a steady state level of for instance 15-20 W, as long as the chainsaw runs or until the battery has been depleted to a predetermined level. As a comparison, a chainsaw motor may work in a range close to 1.5 kW.

This power fed to the handles 5, 7 may be provided using a stored lookup table based on the temperature reading or using a very basic algorithm. In this case, the ambient temperature at start or activation of the chainsaw is the important parameter and measuring the temperature can if desired take place at another location of the saw than one of the handles.

In another example, the temperature sensor 17 is located in one of the handles 5, 7 as illustrated in FIG. 4, and the power boost may vary depending on the instantaneous temperature. For instance, it is possible to set a desired target temperature for the sensor 7 and control the power applied based on the difference between desired and actual temperature, for instance using a PI- or PID controller. Then, the power boost lasts until a target temperature is reached, but the applied power decreases as the measured temperature approaches the target temperature where the steady state power is supplied. Needless to say, such control schemes may be varied in different ways, for instance disabling the handle heat function as a whole if the ambient temperature is above a predetermined threshold.

The invention is not restricted to the described embodiments and may be varied and altered in diverse ways within the scope of the appended claims.

1. A battery powered chainsaw comprising a cutting tool in the form of a saw chain running on a guide bar, a front handle at least partially extending transverse to the elongation of the guide bar and a rear handle extending, at least partially, approximately in the elongated direction of the guide bar, wherein the battery powered chainsaw further comprises a battery-operated heating unit comprising at least one heating element in one of the rear handle, and the front handle, and a temperature sensor,
wherein the heating unit is configured to provide power to the first and/or second heating element based on a reading from the temperature sensor, and
wherein the heating unit is configured to provide, upon activation, a temporary power boost to the first and/or second handle and, subsequently, to provide a steady state power to the first and/or second handle, lower than the power of the power boost.

2. The battery powered chainsaw according to claim 1, wherein the battery-operated heating unit comprises a first heating element in the rear handle and a second heating element in the front handle.

3. The battery powered chainsaw according to claim 1, wherein the temperature sensor is located in the rear handle.

4. The battery powered chainsaw according to claims 2, wherein the first and second heating elements are series connected.

5. The battery powered chainsaw according to any of claim 1, wherein the duration and level of the power boost is determined based on a temperature acquired at start or activation of the chainsaw.

6. The battery powered chainsaw according claim 1, wherein the power boost is continuously controlled.

7. The battery powered chainsaw according to claim 6, wherein power is continuously controlled based on a temperature reading and a PI-regulator.

8. The battery powered chainsaw according to any of claim 1, comprising a compartment for a battery.

9. The battery powered chainsaw according to claim 1, comprising a short-range communications interface.
